(19) United States
(12) Patent Application Publication
(10) Pub. No.: US 2017/0300626 A1
(43) Pub. Date: Oct. 19, 2017

(54) HEALTH CARE MOBILE APPLICATION FOR PROGNOSIS OF PERSONAL CARE SERVICES

(71) Applicant: Roderick A Love, Apopka, FL (US)

(72) Inventor: Roderick A Love, Apopka, FL (US)

(21) Appl. No.: 15/097,357

(22) Filed: Apr. 13, 2016

(51) Int. Cl. G06F 19/00; H04L 29/08; H04L 29/06

(52) U.S. Cl. CPC G06F 19/322; H04L 67/42; G06F 19/327; H04L 67/02; H04L 67/18

(57) ABSTRACT

The present invention relates to implementing an application for prognosis of personal care services in assisting the client(s) to effectively plan the personal care service request. The application is configured to analyze the personal care service record maintained for the client(s) based on which the prognosis is performed and a recommendation is provided to the client(s) for effectively planning the personal care service request. Further, the application is configured to allow the administrator to perform one or more administrative tasks through a web portal of the application.

### FIELD OF THE INVENTION

The present invention generally relates to health care mobile application and more particularly relates to prognosis of personal care services for client(s) determined based on the history of personal care services requested by the client through a mobile application.

### BACKGROUND OF THE INVENTION

There are many health care service systems/applications available in the market that are implemented in the modern mobile computing devices for identifying the client, caregiver, and service actions received and determining activity of the caregiver to be monitored and to verify that the service actions are performed correctly.

Further, the health care service systems/applications provide a GPS hardware that can be used to verify that a caregiver arrived at a particular location at a particular time, and then left the location at a particular later time. This information can corroborate a timesheet, mileage log, or other information submitted by the caregiver.

Further, the health care service systems/applications also provide a comprehensive suite of verification technologies such as the system may capture photographic evidence of the visit (for example, a picture of the patient, caregiver, or both together), GPS location and time information, biometric information (for example, a fingerprint, retina scan, or other biometric signature from the patient and/or caregiver).

Further, the health care service systems/applications may include one or more central servers, datacenters, a cloud-based computing service and it provides a central location where multiple mobile devices, such as mobile device, carried by potentially many caregivers can report monitoring data related to services rendered by the caregivers to the clients.

Further, the health care service systems/applications analyzes the collected verification data and provides various reports available potentially to caregivers, payers, clients, and an operator of the service.

The service may send a challenge via a text message (SMS), an in-application message, email message, push notification, or other alert that asks the caregiver to provide a particular response in a certain amount of time.

However, the existing health care systems/applications do not facilitate prognosis of the health care service for the client(s) based on the analysis performed on the history of the health care services availed by the client(s). Hence, there is a need for an improved or an advanced health care systems/applications that can assist the client(s) in effectively planning the health care services request based on the analysis of the history of the health care services availed by the client(s).

### SUMMARY OF THE INVENTION

The present invention relates to a mobile application for prognosis of personal care services to recommend the client(s) and assist them in effectively planning the personal care services request, wherein the application is configured to receive the personal care service(s) request from the client application. Further, the application is configured to store the received personal care service request in a database storage in the form of a personal care service record associated with one or more clients and is configured to analyze the personal care service record for determining prognosis of personal care services associated with the client(s). Further, the application is configured to recommend the client(s) based on the analysis performed and assist the client(s) in effectively planning the personal care services and to facilitate an administrator to perform one or more activities provided through a web portal of the application.

### BRIEF DESCRIPTION OF DRAWINGS

FIG. 1 illustrates a working overview of the health care management services application.

FIG. 2 illustrates a personal care services web portal for facilitating various health care management related services through an administrator.

FIG. 3 illustrates a login screen used for registering the client(s) into the health care management services application.

FIG. 4 illustrates various categories that are available in the health care management services application.

FIGS. 5a and 5b, illustrate the client database stored in the health care management services application.

FIG. 6, illustrates a list of healthcare management service categories supported by the application.

FIGS. 7a, 7b, 7c, 7d, and 7e, illustrate selecting and scheduling the health care management service(s) for client(s).

FIGS. 8a and 8b, illustrate the sign pad used by the client(s) and the staff used for attesting the service(s) used by the client(s).

FIGS. 9a and 9b, illustrate an icon used for capturing the sign pad of the client(s) and the staff for attesting the service(s) requested by the client(s).

FIG. 10, illustrates the health care management service application used for submitting the service and schedule selected by the user through the administrator console.

FIGS. 11a and 11b, illustrate a database of services and schedules opted by the client(s) through the health care management service(s).

FIG. 12, illustrates the system overview of components used to implement the health care management service application.

### FIGURE DESCRIPTION

100—A system used to implement the health care management service application
101—A network within which the system is implemented
102—A client application interacting with the server application
103—A communication channel established between the client application and the server application
1200—A system overview of components used to implement the application
1201—A Display module
1202—An Analysis module
1203—A Storage module
1204—An Administration module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the health care services application 100 is configured to provide prognosis of personal care services to recommend one or more clients and to assist the client(s) for effectively planning the personal care services request. Further, the health care services application 100 works based on a client-server application interaction within a network 101.

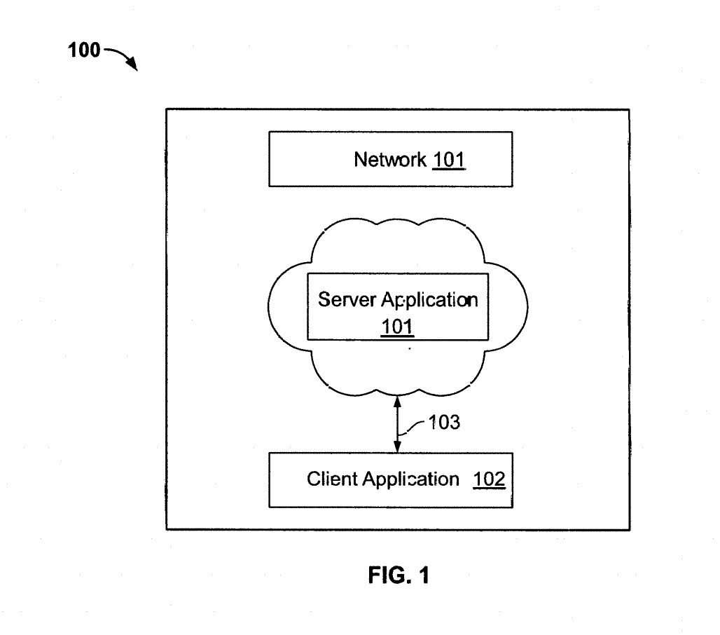

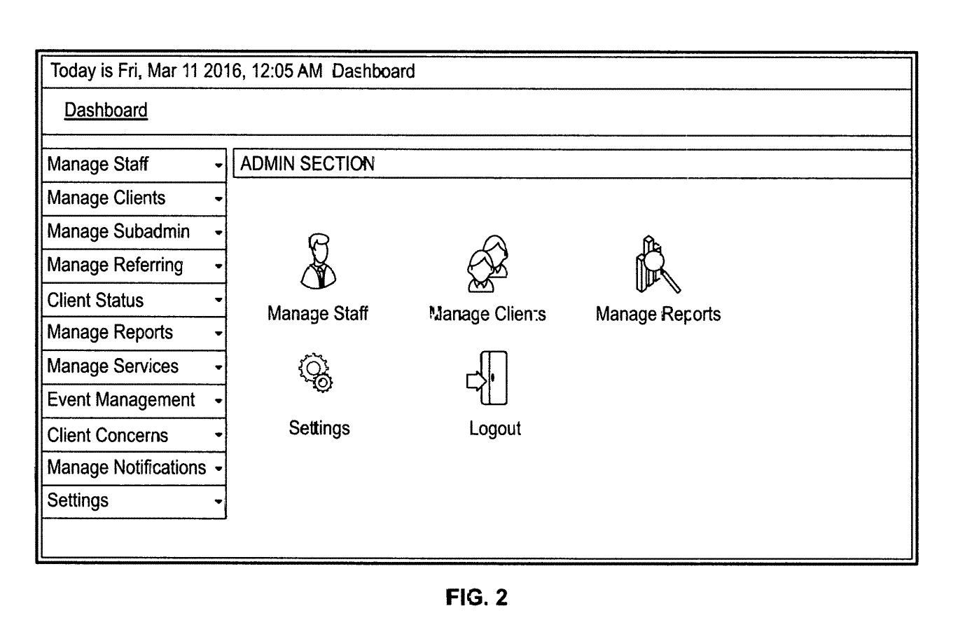

In an embodiment, a mobile device refers to a device on which the client application 102 (with reference to FIG. 1) can be installed for allowing one or more clients to register with the health care services application 100.

In an embodiment, the server application 101 is configured to receive one or more personal care service request from the client application(s) 102 and to store the received personal care service request in database storage in the form of a personal care service record associated with the client(s). Further, the server application 101 is configured to analyze the personal care service record for determining prognosis of personal care services associated with one or more clients based on which the server application 101 recommends the client to effectively plan the personal care services requested by one or more clients. Further, the server application 101 is configured to facilitate an administrator to perform one or more activities through a web portal supported by the application.

In an embodiment, the health care application 100 monitors and measures the itemized home health care services provided to the recipient(s). The recipient(s) are the registered user(s) or client(s) who are availing the health care application services.

The application 100 provides a mechanism that allows the recipient(s) of services to attest the request and the facilitated service through a signature pad provided on a mobile device, wherein the attestation can be performed using a finger based signature as a proof of service(s) request and/or availed service provided to the recipient(s). The application 100 provides a signature pad for a staffer to initiate an attestation of services or the services rendered to the recipient(s) of the health care service(s).

In an embodiment, the application 100 provides a geographic coordinates of location of services provided as a compliment of further proof of attendance of staff to the recipient(s). The application also provides a client calendar for staff and an initial face sheet of client image, and client demographic information (address) with GPS directions to the client address.

In an embodiment, the application 100 provides the ability of staff to input client concerns/issues regarding the service(s) provided to the client. Further, a master control administrative dashboard Customer Relationship Management (CRM) generates a client service algorithm of services rendered. The CRM also generates a client service report based on the duration length designated, and the dashboard generates a multitude of staff and client reports as well as client service utilization reports and alerts.

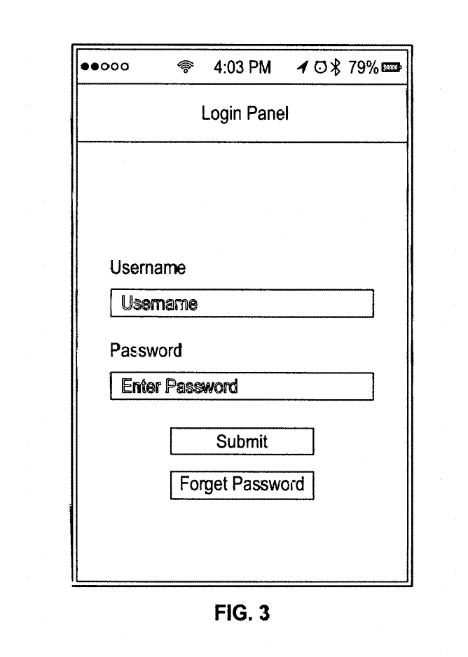

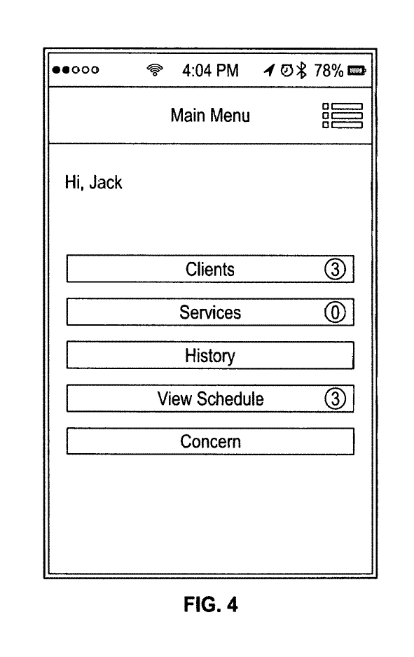

Referring to FIG. 3 illustrates a login screen used for registering into the health care management services application 100. In an embodiment, the health care management service application 100 installed on the mobile device allows the user to register with the application for allowing the registered user to select and schedule the service(s) provided by the health care management application 100.

[Referring to FIG. 4 illustrates various menu categories that are listed in the health care management services application main menu screen/opening screen. In an embodiment, the main menu screen provides a Client category for displaying the registered client list, a Services category for displaying the service provider details, a History category for displaying the services provided to the clients, the services availed by the client, and the service providers related information through the health care management services, a Schedule viewing category to enable the viewers to view the schedule selected for the services, and a Concern category for raising the concerns and issues associated with the services provided to the client(s) through the health care management services application 100.

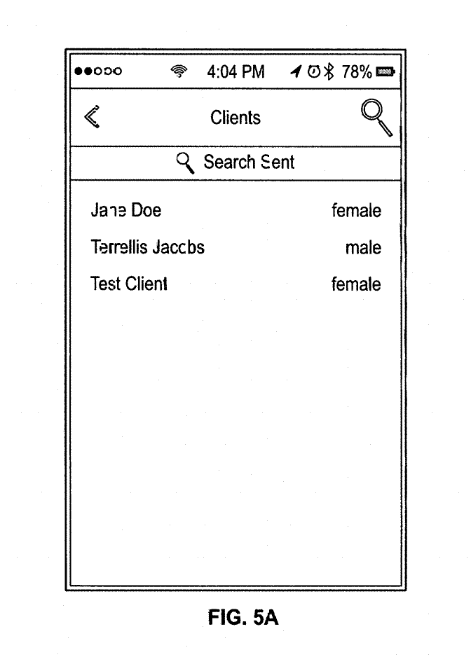

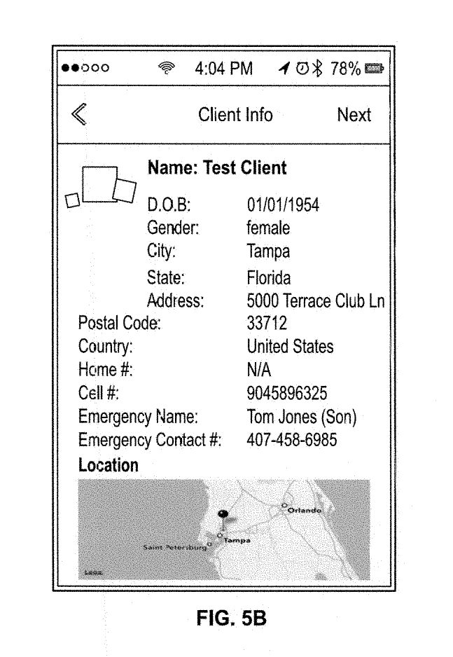

Referring to FIGS. 5a and 5b, illustrate the client database stored in the health care management service application 100. In an embodiment, the client database is configured to store the client details availing the service(s) provided through the health care management service application 100. The client database stores information related to the client profile.

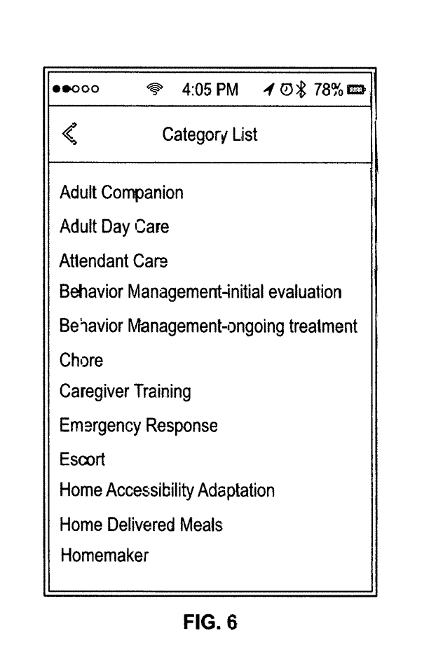

Referring to FIG. 6, illustrates a list of health care management service categories supported by the application 100. In an embodiment, the health care management service provides a list of services to the registered client. For example, the list of services provided to the registered client includes but not limited to facilitating company to an adult, providing day care for an adult, facilitating an emergency response service, delivering meals to the client.

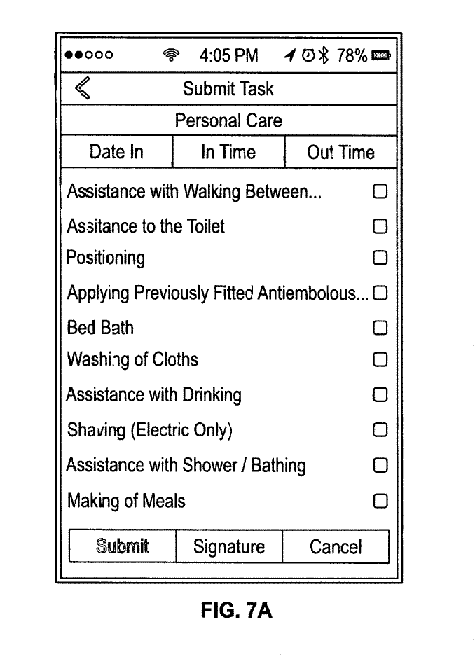

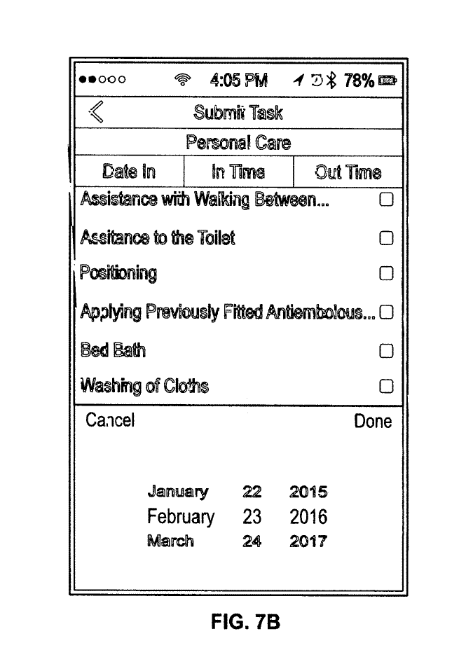

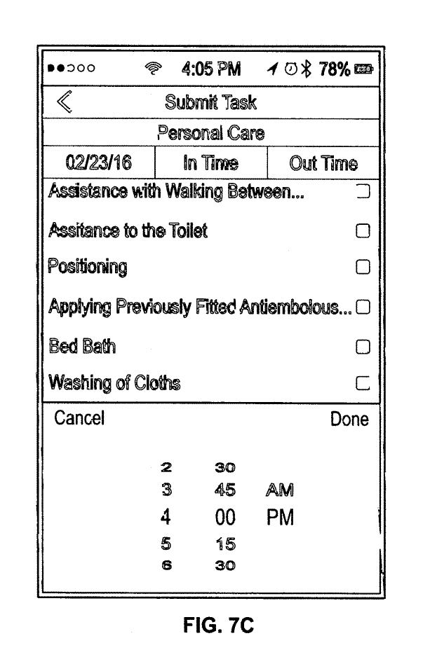

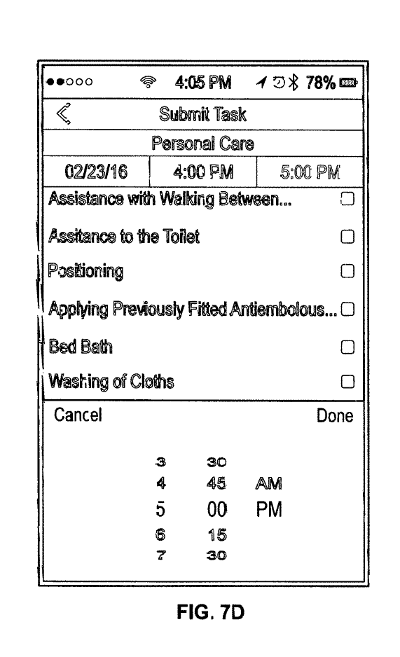

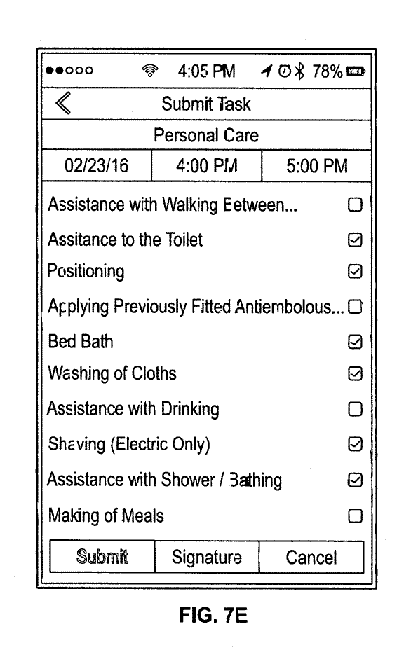

FIGS. 7a, 7b, 7c, 7d, and 7e, illustrate selecting and scheduling the health care management service(s) for the client(s). In an embodiment, the application 100 allows the user to select the required service(s) along with the details about the requirement of the service(s). For example, the client can request service for washing clothes, shaving, and assistance to toilet during specific days within a specified time interval. Based on the service selected and as per the selected schedule, the health care management service application 100 provides relevant service to the client(s).

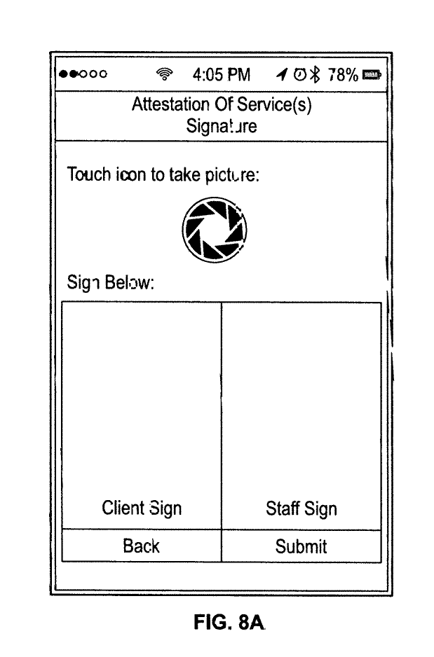

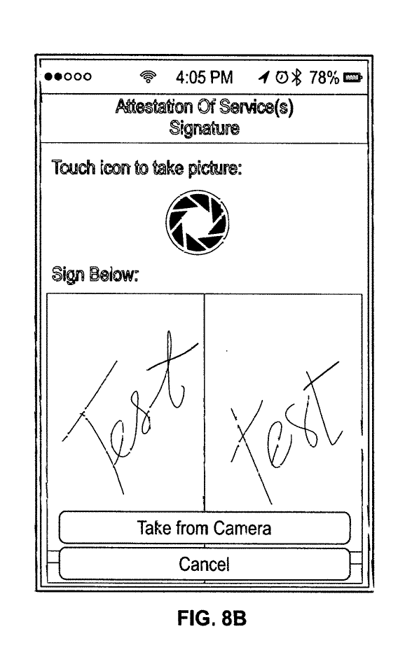

FIGS. 8a and 8b, illustrate the sign-pad used by the client(s) and the staff for attesting the service(s) requested and availed by the client(s). In an embodiment, the application 100 allows the client(s) requesting the service and the staff providing the service to sign-off through the sign-pad provided by the health care management service application 100. The sign-off activity recorded by the application 100 acts a proof of service requested by the client(s) and the service provided by the staff as per the request sent/initiated by the client(s).

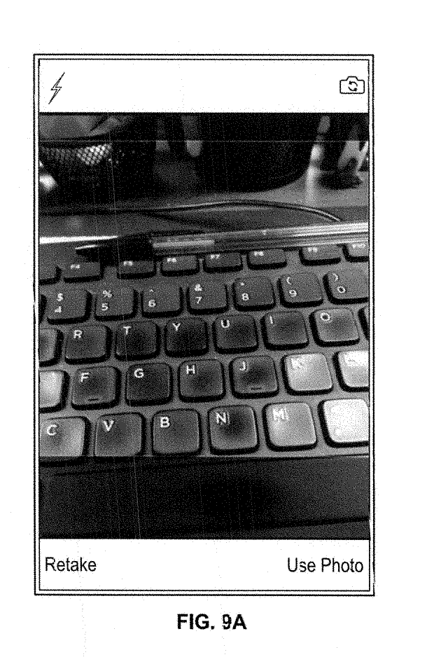

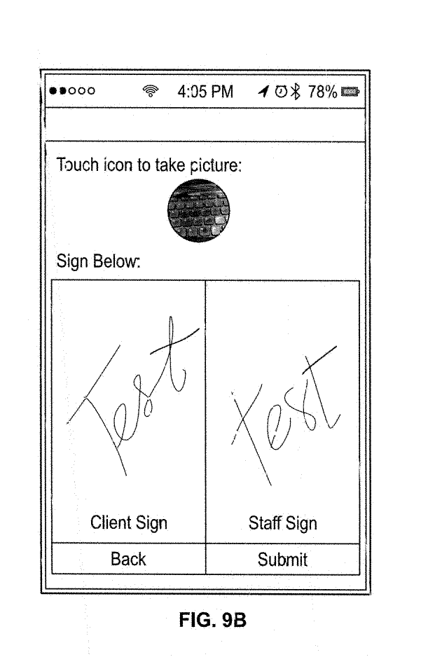

FIGS. 9a and 9b, illustrate an icon used for capturing the sign-pad of the client(s) and the staff for attesting the service(s) requested and availed by the client(s).

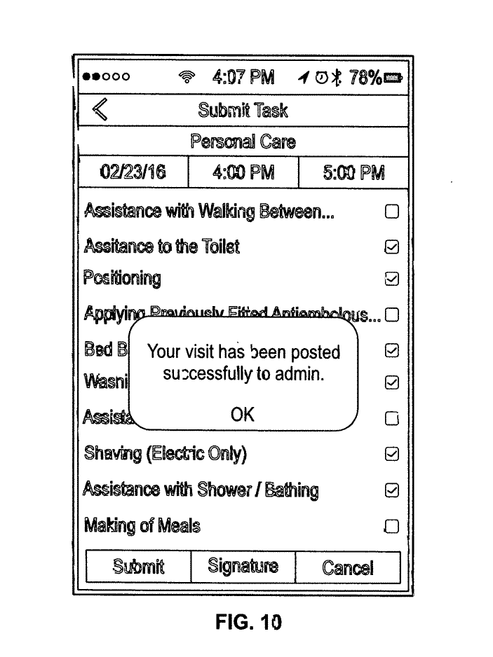

FIG. 10, illustrates the health care management service application used for submitting the service and schedule selected by the client through the web portal. In an embodiment, the service(s) and schedule selected and submitted by the client(s) are received at the server application 101. Further, the server application 101 processes and analyzes the request submitted by the client(s).

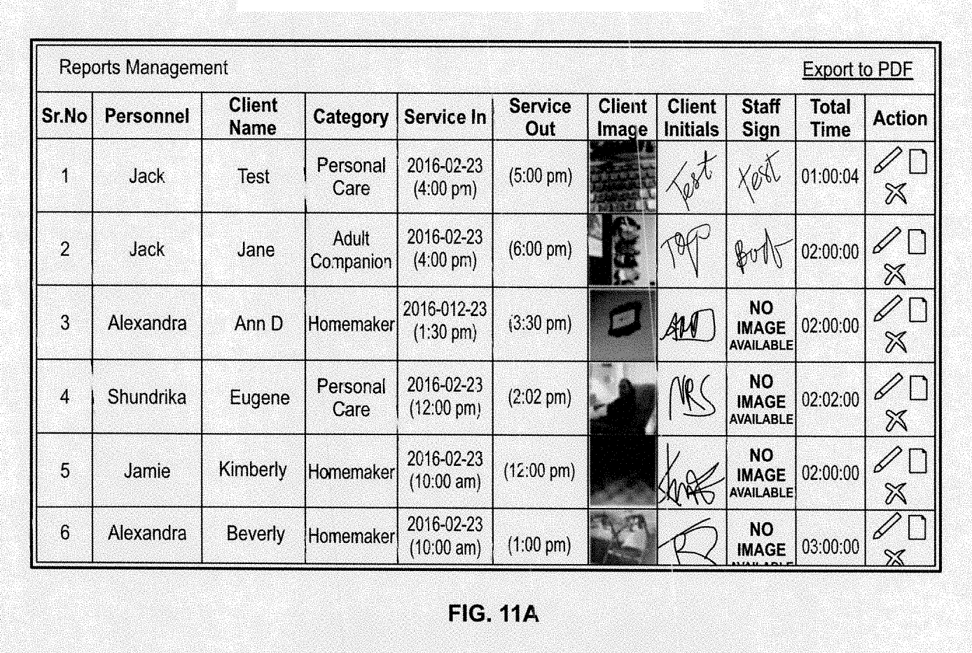

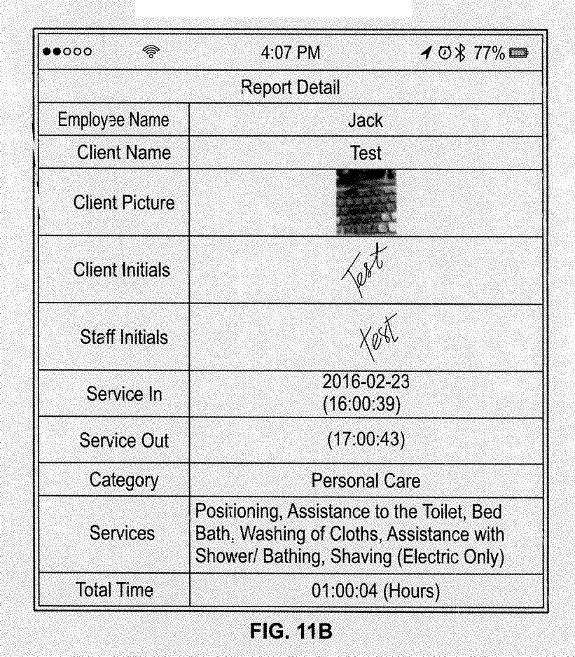

FIGS. 11a and 11b, illustrate a database of services and schedules opted by the client(s) through the health care management service(s). In an embodiment, the database of services and schedules opted by the client is stored in the database and can be viewed for later reference and/or can be used for further analysis. The database can be stored in a cloud server, a database server, and/or a network server.

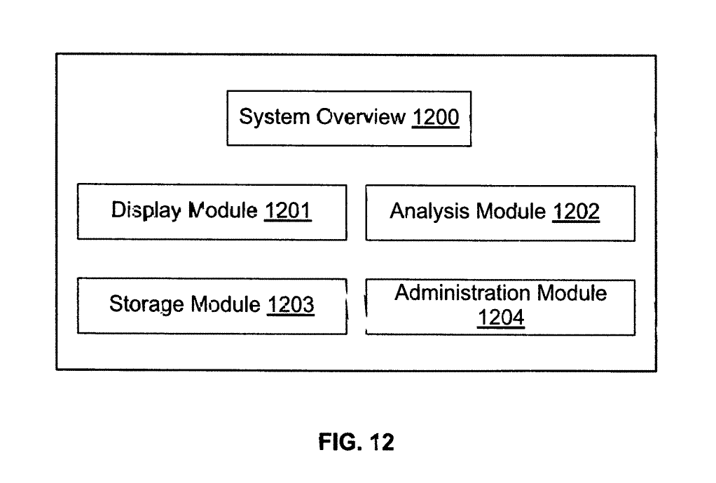

FIG. 12, illustrates the system overview of components used to implement the health care management service application. In an embodiment, implementation of the health care management service application 100 comprises of the following components: a Display module 1201, an Analysis module 1202, a Storage module 1203, and an Administration module 1204. The Display module 1201 is configured to perform the following activities: receive inputs from a client to register the client with the application 100, receive a service request from the client, receive a command from an administrator to manage the elements of the application 100, wherein the elements of the application 100 comprises of a staff to provide a client service, a client requesting a health care management service, one or more administrators identified to manage the reports, staff, clients, issues/concerns through the application 100. The Analysis module 1202 is configured to analyze the service request received through the application 100 based on which the prognosis of personal care services is determined to recommend the client(s) to effectively plan the personal care services request. The Storage module 1203 is configured to store the details received through the client application 102, wherein the details received through the client application 102 includes but not limited to the registered client details, staff details, analysis and reports associated with the client's personal care services, or the like. The Administration module 1204 is configured to manage and view various elements supported by the application 100.

1. A mobile application for prognosis of personal care services to recommend at least one client for assisting said at least one client in effectively planning the personal care services request, wherein said application is configured to:
receive at least one personal care service request from at least one client application;
store the received said at least one personal care service request in a database storage in the form of a personal care service record associated with said at least one client;
analyze the personal care service record for determining prognosis of personal care services associated with said at least one client;
recommend said at least one client based on the analysis performed to effectively plan the personal care services request for said at least one client; and
facilitate an administrator to perform at least one activity associated with a web portal supported by said application.

2. The application as claimed in claim 1, wherein said application is configured to implement an algorithm to effectively analyze the personal care service record based on which said at least one client is recommended to effectively plan the personal care services request.

3. The application as claimed in claim 1, wherein said application configured to receive said at least one personal care service request from said at least one client application can be classified under one of the following categories: a homemaker service, a personal care service, an adult day care service, an emergency response service, an adult companion service, or the like.

4. The application as claimed in claim 1, wherein said application is configured to allow an administrator to perform said at least one activity that includes but not limited to: managing the staff, managing the clients, managing the administrators, managing reports, managing the services, managing notification, managing client concerns, or the like.

5. A system used for implementing a mobile application for prognosis of personal care services to recommend at least one client for assisting said at least one client in effectively planning the personal care services request, wherein said system comprises of a server application, a client application and is configured to:
receive at least one personal care service request from at least one client application;
store the received said at least one personal care service request in a database storage in the form of a personal care service record associated with said at least one client through said server application;
analyze the personal care service record for determining prognosis of personal care services associated with said at least one client through said server application;
recommend said at least one client based on the analysis performed to effectively plan the personal care services request for said at least one client through said client application; and
facilitate an administrator to perform at least one activity associated with a web portal supported by said application.

6. The system as claimed in claim 5, wherein said system is configured to implement an algorithm on said server application to effectively analyze the personal care service record based on which said at least one client is recommended to effectively plan the personal care services.

7. The system as claimed in claim 5, wherein said system is configured to receive said at least one personal care service request from said at least one client application that can be classified under one of the following categories: a homemaker service, a personal care service, an adult day care service, an emergency response service, an adult companion service, or the like.

8. The application as claimed in claim 5, wherein said system is configured to allow an administrator to perform said at least one activity that includes but not limited to: managing the staff, managing the clients, managing the administrators, managing reports, managing the services, managing notification, managing client concerns, or the like.
